(19) United States
(12) Patent Application Publication
(10) Pub. No.: US 2006/0252878 A1
(43) Pub. Date: Nov. 9, 2006

(54) Plasticized aqueous alkali-soluble resin coating compositions with reduced odor and pH

(76) Inventors: Jason M. Razdik, Kenosha, WI (US); Russell O. Carlsen, Racine, WI (US); John E. Blasko, Racine, WI (US)

Correspondence Address: S.C. JOHNSON & SON, INC., 1525 HOWE STREET, RACINE, WI, 53403-2236, US

(21) Appl. No.: 11/124,760

(22) Filed: May 9, 2005

(51) Int. Cl. C09D 5/02

(52) U.S. Cl. 524/556

(57) ABSTRACT

This invention provides an alkali-soluble resin coating composition, more particularly an aqueous floor polish composition, comprising water, at least one alkali-soluble polymeric film forming agent, preferably solubilized in water using ammonia or an ammonia derivative, a polyvalent metal crosslinking agent, and a plasticizing agent, wherein the improvement comprises at least a portion of the plasticizing agent being formed of a weak carboxylic acid, such as a tertiary alkyl monocarboxylic acid, or an unsaturated primary carboxylic acid, each acid having an average of from about 6 to 30 carbon atoms per molecule, or combinations thereof. Such compositions have one or more improved properties such as greatly reduced ammonia odor as compared with the same compositions using only conventional plasticizers such as tributoxyethyl phosphate, reduced pH of the composition to increase ease of handling the composition, improved or equal coating film leveling, and improved gloss development and mark resistance with good self-sensitivity for less buildup upon recoating.

### BACKGROUND OF THE INVENTION

1. Technical Field

This invention relates to an aqueous coating composition such as a floor polish that contains one or more weak acids that function as a pH buffering agent, a plasticizing agent and an odor reducing agent.

2. Background Art

Aqueous coating compositions are well known and find use as protective coatings for various substrates such as wood, metal, plastic and the like. Such compositions typically contain a film-forming polymer such as an acrylic polymer. That polymer forms a continuous protective coating over the substrate, often in conjunction with other additive materials such as other polymers, resins, pigments, dyes, ultraviolet light absorbing agents and the like, to help protect it from damage caused by the sun, abrasion, foot traffic, pressure, and so forth. The film-forming polymers are typically selected for their physical properties such as water resistance, flexibility, hardness, resilience, toughness, scratch and marking resistant (black heel marks) and the like to fit the needs of the substrate being protected and the environment in which the coating will be used.

One way to modify the properties of the polymers included in the coating composition is to include a “plasticizing agent” or “plasticizer”. A plasticizing agent is typically a compound that can associate with the polymer and thereby modify the physical properties of the polymer or of the coating composition itself. For example, a plasticizing agent may serve to change the hardness, flexibility, glass transition temperature (Tg) to form a continuous film. The plasticizing agent is thus used to impart desirable properties to the film left behind when the coating composition is applied to the substrate and the volatile components are removed such as by drying. These desirable results are achieved by the plasticizing agent without having to change the nature of the polymer itself or to obtain properties that are not possible to get by simply modifying the polymer itself.

Additionally, many coating compositions of the above types include ammonia or other ammonia derivatives due to the fact that the coatings are formed with alkali-soluble resins. These resins only dissolve in alkaline solutions, requiring that an amount of a base, and preferably ammonia or an ammonia derivative, is added to the aqueous solution to solubilize all the components of the composition and enable the polymer to form a suitable dispersion in the aqueous solution. Additionally, the presence of the ammonia assists in the formation of the film by the increasing the open time for the composition resulting in better film formation.

However, when these aqueous resins dispersions are formed with ammonia, or an ammonia derivative, the presence of these compounds in the dispersion causes certain detrimental aspects in the dispersions and flooring coatings formed with these dispersions. Specifically, the ammonia provides the composition with the distinctive, and unpleasant smell or odor. Also, often times the amount of ammonia used is greater than the amount actually required to solubilize the resins. The excess ammonia elevates the pH of the overall coating, making the coatings at times more difficult to handle. Therefore, it is desirable to develop a flooring polish composition which includes a component that reduces or neutralizes substantially all of the excess ammonia odor in these alkali-soluble resin dispersions.

### BRIEF SUMMARY OF THE INVENTION

It is a primary object of this invention is to provide an all-resin aqueous coating composition used as a floor polish that is formed by solubilizing the resin with an alkaline material, such as ammonia or an ammonia derivative, and that also may contain a polyvalent metal crosslinking compound, especially floor polish compositions, with one or more weak acids that neutralize the ammonia in the composition, thereby reducing the pH of the composition, improving certain physical properties of the film formed by the composition, improving the gloss properties of the polish, and significantly reducing the ammonia odor of the composition.

This and other objects of the present invention are provided by an aqueous coating composition, more particularly by an aqueous floor polish composition, comprising water, at least one alkali-soluble polymeric film forming agent, and optionally a polyvalent metal crosslinking complex, and a plasticizing agent, wherein the improvement comprises at least a portion of the plasticizing agent being selected from one or more weak acids. These weak acids can be selected from those carboxylic acids that are useful in neutralizing ammonia or ammonia derivatives, including aromatic carboxylic acids, water-soluble and water-insoluble carboxylic acids and unsaturated carboxylic acids. Specifically, weak carboxylic acids such as a tertiary alkyl monocarboxylic acid containing an average of from about 6 to about 30 carbon atoms per molecule or an unsaturated primary carboxylic acid containing an average of 6 to about 30 carbon atoms per molecule can be utilized.

More particularly, the monocarboxylic acid is selected from those of the formula RR′R″CCOOH wherein each R, R′ and R″ group is an alkyl group containing at least one carbon atom and the average total number of carbon atoms in each R, R′ and R″ group is in the range of from 4 to about 30. More preferably, the average total number of carbon atoms in each R, R′ and R″ group is from about 4 to 20. Even more preferably, the average total number of carbon atoms in each R, R′ and R″ group is from about 7 to about 14. Most preferably, the average total number of carbon atoms in each R, R′ and R″ group is from about 7 to about 10.

Further, the unsaturated primary carboxylic acid is selected from those of a formula RC═CR₁COOH wherein each R and R₁ group is an alkyl group containing at least one carbon atom and the average total number of carbon atoms in each R, R₁ group is in the range of from 4 to about 30. More preferably, the average total number of carbon atoms in each are in R and R₁ group is from about 4 to 20. Even more preferably, the average total number of carbon atoms in each R and R₁ group is from about 7 to about 14. Most preferably, the average total number of carbon atoms in each R and R₁ is from about 7 to about 10.

This invention also relates to a method of improving the physical properties of an aqueous, alkali-soluble resin coating composition, more particularly of an aqueous floor polish composition, comprising water, at least one alkali-soluble polymeric film forming agent, optionally, a polyvalent metal crosslinking compound and a plasticizing agent, wherein the improvement comprises replacing at least a portion of the plasticizing agent with one or more weak acids, such as primary carboxylic acids, including a tertiary alkyl monocarboxylic acid and/or an unsaturated primary or tertiary carboxylic acid, each acid containing an average of from about 6 to about 30 carbon atoms per molecule.

### DETAILED DESCRIPTION OF THE INVENTION

The aqueous coating compositions of the present invention are an improvement over conventional aqueous coating compositions, particularly over aqueous floor polish compositions which are well known in the art and that contain ammonia or ammonia derivatives for solubilizing the film forming resins used in forming the coating compositions.

The composition contains at least one alkali-soluble film-forming polymer that is plasticized by the plasticizing agent which requires that the plasticizing agent be sufficiently soluble in the film-forming polymer to affect its physical properties. Such polymers may be natural resins or polymers, including but not limited to rosin resin, or synthetic resins or polymers, including but not limited to addition polymers including acrylic polymers and styrene/acrylic polymers or condensation polymers including polyester polymers, polyurethane polymers, polyether polymers, polyaldehyde polymers, polycarbonates and polyamides.

The film-forming polymers must be soluble or dispersible in water including an alkaline component, such as ammonia or an ammonia derivative, that permits the polymer to be solvated by water and either dissolved in water to form a clear solution or dispersed in water to form an aqueous dispersion of the polymer. As is well known in the art, film-forming polymers, especially those of relatively high molecular weight (for example, those over 100,000 number average molecular weight) which may or may not contain functional groups can be emulsified in water with the assistance of surface active agents to form aqueous emulsions or latices of the polymers.

The molecular weight of the film-forming polymers can vary depending upon the ultimate use of the aqueous coating composition. Film-forming polymers of lower molecular weight such as polymers of styrene and acrylic acid generally have number average molecular weights of from about 1,000 to 6,000-10,000 and are water soluble when neutralized with inorganic or organic alkaline materials, including any suitable ammonia compound or ammonia derivative, such as a primary amine, secondary amine or tertiary amine compound, and that is preferably ammonium hydroxide, monoethanolamine, dimethyl ethanolamine, morpholine or triethanolamine when a sufficient level of carboxylic acid groups is present in the polymer. However, these polymers usually require a crosslinking agent to harden the film. In floor polish compositions, the crosslinking agents take the form of polyvalent metal complexes in odor to crosslink the polymers sufficiently to form the film upon application of the composition to a substrate.

Addition polymers such as acrylic polymers are often used in aqueous coating compositions with plasticizing agents. Such acrylic polymers are well known in the art and are typically prepared from monomers such as acrylic acid, methacrylic acid, and substituted or unsubstituted C.sub. 1-C.sub.20 alkyl esters of such acids (e.g., methyl methacrylate, butyl acrylate, butyl methacrylate, 2-ethylhexyl acrylate, octyl acrylate, and 2-hydroxyethyl methacrylate). Such acrylic polymers may further include aromatic vinyl monomers such as styrene and alpha-methyl styrene. The monomers are selected to provide the desired properties needed in the film formed from the polymer such as hardness, glass transition temperature, adhesion, and the like as is well known in the art. Floor polish compositions generally use acrylic polymers that are typically formed from methacrylic acid as the hydrophilic monomer along with monomers such as butyl acrylate and styrene.

Preferably, alkali soluble resins of the type conventionally used in aqueous floor polish compositions such as copolymers of acrylic acid and styrene of number average molecular weight from about 1,000 to about 5,000 having acid values of from about 140 to 350 milligrams of potassium hydroxide per gram of resin can be used in amounts of up to about 100% based on the total nonvolatile content of the composition to improve the leveling of the coating compositions, particularly of aqueous floor polish compositions.

If one or more of the polymers present contain ligands such as carboxyl groups that can reversibly associate with metal fugitive ligand complexing agents, then the latter compounds such as zinc ammonium carbonate, zirconium ammonium carbonate, and other zinc, cadmium, copper and nickel ammonium carbonate, ammonium formate or ammonium acetate complexes as well as titanate complexes of such metals, can be included to provide cured, but strippable floor polish compositions. In conjunction with such complexing agents other than zirconium, a stabilizer such as ammonium hydroxide or a water-soluble nonionic ethyleneoxide condensate emulsifier may also be used.

The compositions of the present invention further include an effective amount of at least one plasticizing agent. The plasticizing agent must be sufficiently soluble in at least one of the film-forming polymers to modify the physical properties of the polymer to a desirable degree such as hardness or glass transition temperature. Depending upon the properties desired in the coating left behind after drying, the amount of plasticizing agent used based on the total amount of film-forming polymer and plasticizing agent can be 50% or greater by weight. A more typical level of plasticizing agent, particularly for aqueous floor polish compositions, is where the plasticizing agent is present as from about 0.1% to 25% by weight of the total weight of plasticizing agent and film-forming polymers.

Examples of conventional plasticizing agents include permanent plasticizers that remain in the film after drying include butyl benzyl phthalate, dibutyl phthalate, dimethyl phthalate, triphenyl phosphate, 2-ethylhexyl benzyl phthalate, butyl cyclohexyl phthalate, mixed benzoic acid and fatty oil acid esters of pentaerythritol, poly(propylene adipate) dibenzoate, diethylene glycol dibenzoate, tetrabutylthiodi-succinate, butyl phthalyl butyl glycolate, triethyl citrate, acetyl triethyl citrate, tributyl citrate, acetyl tributyl citrate, dibenzyl sebacate, tricresyl phosphate, tributoxyethyl phosphate, toluene ethyl sulfonamide, the di-2-ethylhexyl ester of hexamethylene glycol diphthalate, di-(methylcyclohexyl)-phthalate, and tributyl phosphate. In conventional aqueous polish compositions based on acrylic film-forming polymers, tributoxyethyl phosphate, such as that sold under the trade name KP-140 sold by Great Lakes Performance Additives and Fluids of West Lafayette, Ind., is the preferred plasticizing agent of choice because it not only serves as a plasticizing agent, but also as a leveling and defoaming agent.

Examples of conventional fugitive plasticizers that are sufficiently volatile that they substantially leave the coating film upon drying include the monomethyl or monoethyl ether of diethylene glycol, isophorone, benzyl alcohol, and 3-methoxy-1-butanol.

The types and amounts of such plasticizing agents selected are based on the demand for compatibility and efficiency of the agents to affect the hardness and flexibility of the coating film left behind after drying.

Additional minor amounts of other ingredients can also be included to improve the performance of the compositions of the present invention. Specifically, other ingredients that are commonly included in coating compositions, particularly in floor polish compositions, in minor amounts can be included in the improved compositions of the present invention. Ingredients of this type include waxes such as polyethylene and polypropylene waxes, surfactants—particularly those of the nonfoaming type—such as anionic, nonionic or amphoteric surfactants such as ethoxylated fatty alcohols, alkyl sulfonates and ethoxylated alkyl sulfonates, fluorochemical compound leveling agents, and organic solvents to act as coalescing agents and to extend the drying time and leveling of such compositions such as polyhydroxy polyethers, lower alkanols or high boiling glycols.

The balance of the required composition comprises water. Sufficient water is used to provide a suitable viscosity for application to the surface to be coated.

The improvements provided by the present invention relates to the substitution of some or all of the plasticizing agent used in an ammonia-solubilized resin aqueous floor polish composition with a plasticizing agent that is formed of one or more weak carboxylic acids, that can be aromatic carboxylic acids, unsaturated carboxylic acids, certain water soluble and water-insoluble carboxylic acids, and combinations thereof. Preferred carboxylic acids of these types include acetic acid, benzoic acid, phthalic acid and citric acid which reduce buildup on the film and increases the self-sensitivity of the film when utilized, and a tertiary alkyl monocarboxylic acid containing an average of from about 6 to about 30 carbon atoms per molecule. The monocarboxylic acids can be represented by the formula RR′R″CCOOH wherein each R, R′ and R″ group is an alkyl group containing at least one carbon atom and the average total number of carbon atoms in each R, R′ and R″ group is in the range of from 4 to about 30. More preferably, the average total number of carbon atoms in each R, R′ and R″ group is from about 4 to 20. Even more preferably, the average total number of carbon atoms in each R, R′ and R″ group is from about 7 to about 14. Most preferably, the average total number of carbon atoms in each R, R′ and R″ group is from about 7 to about 10.

As noted earlier, such monocarboxylic acids are commercially available from Exxon Chemical Americas and Shell Chemical Company. Such monocarboxylic acids are synthetically produced materials that are typically supplied as a mixture of isomers of acids of various carbon chain lengths except for a few products that are refined to substantially comprise a relatively uniform carbon chain length. One example of such a refined product is Exxon's Neodecanoic Acid, Prime Grade, that is reported to be 98% tertiary alkyl monocarboxylic acid of 10 carbon atoms and 2% tertiary alkyl monocarboxylic acid of 9 carbon atoms.

Furthermore, the plasticizing agent can be formed from an unsaturated primary carboxylic acid containing an average of from about 6 to about 30 carbon atoms per molecule. Such unsaturated primary carboxylic acids can be represented by the formula RC═CR₁COOH wherein the R and R₁ groups are alkyl groups that contain at least one carbon atom and the average total number of carbon atoms in each of the R and R₁ groups is in the range from about 4 to about 30. More preferably, the average total number of carbon atoms in each R and R₁ groups is from about 4 to 20. Even more preferably, the average total number of carbon atoms in the R and R₁ groups is from about 7 to about 14 while most preferably being between about 7 to about 10. Examples of suitable unsaturated primary carboxylic acids include oleic acid such as that sold under the trade name Priolene 6900 OLA available from Alliance-Unichem.

The film-forming polymers must be selected with the polymer solubility of the weak acids in mind. If the weak acids are not soluble in the polymer to the extent that it is effective to modify the physical properties of the polymer, then the weak acids will not be useful to replace a portion of the plasticizing agent. While some applications may permit one to replace the entire amount of plasticizing agent with the weak acids used in the present invention, it is more desirable to only substitute a portion of the plasticizing agent present with the weak carboxylic acids of the present invention.

In aqueous floor polish compositions, particularly those based on acrylic polymers, it is preferred that when the total amount of plasticizing agent is from 0. 1% to 10% of the total weight of plasticizing agent and film-forming polymer, that the weak acid(s) be from about 20% to 80% of the total weight of the plasticizing agent present. A presently preferred combination of plasticizing agents for aqueous floor finish compositions is to use tributoxyethyl phosphate as the remainder of the plasticizing agent along with the foregoing amount of the weak acid(s).

Similarly, in aqueous floor polish compositions, particularly those based on acrylic polymers, it is preferred that when the total amount of plasticizing agent is from 10% to 25%, and more preferably from 10% to 20%, of the total weight of plasticizing agent and film-forming polymer, that the tertiary monocarboxylic acid be from about 20% to 60% of the total weight and the unsaturated primary carboxylic acid be from about 5% to 30% of the total weight of the plasticizing agent present. A presently preferred combination of plasticizing agents for aqueous floor polish compositions is to use tributoxyethyl phosphate as the remainder of the plasticizing agent along with the foregoing amounts of tertiary monocarboxylic acid and unsaturated primary carboxylic acid.

Use of more than the maximum levels of weak acids given above in aqueous floor polish compositions containing tributoxyethyl phosphate was found to cause an undesirable decrease in the hardness of the film formed by the composition, resulting in increased damage to the film as a result of normal traffic on the film.

It has been unexpectedly found that the substitution of a portion of weak carboxylic acids, and particularly weak tertiary and primary carboxylic acids in place of a majority of the tributoxyethyl phosphate plasticizing agent used in prior aqueous floor polish compositions including ammonia-solubilized resin film formers, and including zinc or other polyvalent metal complexing agents, resulted in compositions having a much lower pH and a greatly reduced ammonia odor. This is due to the presence of the weak acids, which in addition to their function as a plasticizer, function to neutralize the excess ammonia or ammonia derivative present in the composition.

This invention provides, in its more preferred embodiment, an aqueous floor polish composition for application to wood, vinyl, concrete and other types of flooring materials. These compositions are applied with conventional floor polishing application equipment such as pad applicators, sprayers, motorized application equipment and the like.

In its broader aspects, ammonia-solubilized, metal-crosslinked aqueous resin coating compositions are provided that can be used as polishing coatings for wood, metal, glass, plastic and the like where the physical properties of the coating composition can be tailored to the needs of the substrate being polished and the intended use of the coating by the choice and amount of weak acid(s) used as the plasticizing agent.

The following Example is provided to show various aspects of the present invention without departing from the scope and spirit of the invention. Unless otherwise indicated, all parts and percentages used in the following Examples are by weight.

### EXAMPLE

This example illustrates a preferred formulation for a prototype floor polish into which the previously referred to tertiary carboxylic acids, primary carboxylic acids and conventional plasticizers were each incorporated.

Floor Polish Formula:

| Weight | | | | Function Within the |
|---|---|---|---|---|
| Percent | Common Name | Chemical Name | Purpose | Formulation |
| 58.9 | Deionized water | Water | Solvent/carrier | Carrier or solvent for rest |
| | | | | of ingredients |
| 0.5 | 1% Wetting Agent | Fluorocarbon surfactant | Surfactant, | Wetting of substrate |
| | | | wetting agent | |
| 0.7 | 28% ammonia | Ammonium hydroxide | Base | Reacts with acid groups on |
| | | | | resin to solubilize it; adjust |
| | | | | pH for stripping efficiency |
| 1.1 | Dowanol DE | Diethylene glycol | Solvent | Aids film formation; wetting |
| | | monoethyl ether | | |
| 0.4 | KP140 | Potassium tributoxyethyl | Plasticizer | Aids film formation; |
| | | phosphate | | wetting defoaming |
| 0.6 | 35% zinc ammonium | Zinc ammonium | Metal ion | Divalent zinc crosslink of |
| | carbonate | carbonate | cross-linker | acid groups on resin; |
| | | | | resolubilized by |
| | | | | ammoniated cleaners |
| 36.5 | 25% solids alkali | Acid functional resin | Resin film former | Main component of dry film |
| | soluble resin solution | solubilized with | | |
| | | ammonia in water | | |
| 2.1 | 25% AC 392 | Polyethylene wax | Wax | Provides scratch, scuff, |
| | | dispersion | | mar resistance |
| 0.8 | 40% E-43 | Polypropylene wax | Wax | Used primarily to reduce the |
| | | dispersion | | slipperiness of the dry film |
| 0.7 | Oleic Acid | Oleic acid | Fatty acid and | Binds excess ammonia; |
| | | | plasticizer | aids in film formation |
| 1.1 | Neodecanoic Acid | Neodecanoic acid | Acid and plasticizer | Binds excess ammonia |

The following general procedures were employed for producing the products set forth in the Example: A suitable blending vessel is charged with water, the solvents such as the DE and the fluorochemicals such as Zonyl FSJ from DuPont. With good agitation, the water/solvent/fluorochemicals are mixed for a minimum of three minutes. The ammonia-solubilized resin dispersion and ammonium hydroxide are then added and mixing is continued for a minimum of three minutes. The polyethylene wax dispersion, such as AC392 Wax is added with a continued mixing for a minimum of three minutes. The zinc ammonium carbonate solution is slowly added subsequently in a steady stream or subsurface addition and mixing continued for a minimum of ten minutes. The plasticizer(s) such as KP 140, and all the additives mentioned in the Example including neodecanoic acid, and oleic acid are next added. The plasticizers need to be added slowly in a steady stream or in portions and allowed to diffuse into the finish formulation with adequate mixing. If the plasticizer(s) are added too quickly, coagulum or gel or particulate can form. After all the plasticizer is added, mixing is continued for a minimum of ten minutes. The final addition is the E-43 polypropylene wax emulsion. After addition of polypropylene wax dispersion, continue to mix for a minimum of twenty minutes. The resulting floor polish is then filtered through a 50 micron filter and allowed to come to equilibrium for a minimum of twenty-four hours and preferably seventy-two hours before being evaluated.

Other formulations for coating compositions formed according to the present invention can be made as resin cuts, with a preformed all-resin coating composition being diluted or cut with a suitable solvent, such as water, NDA or oleic acid, to form a composition with a desired solids and/or non-volatile component content. Some examples of coating compositions made in this manner are as follows:

EXAMPLE 1
30% NV Resin Cut

| Ingredients | Wt % | NV | NV % | Gms | |
|---|---|---|---|---|---|
| DI Water | 57.920 | | | 405.440 | |
| Water left out | 5.000 | | | 35.000 | |
| 28% Ammonia | 7.080 | | | 49.560 | |
| Rosin Resin A | 25.012 | 25.012 | 83.372 | 175.081 | pH = 8.25 |
| Tall Oil Fatty Acid | 1.843 | 1.843 | 6.144 | 12.902 | |
| (TOFA) | | | | | |
| Neodecanoic Acid | 2.927 | 2.927 | 9.757 | 20.490 | |
| NDA | | | | | |
| KP-140 | 0.000 | 0.000 | 0.000 | 0.000 | |
| Zinc Oxide | 0.218 | 0.218 | 0.727 | 1.527 | |
| Total | 100.000 | 30.000 | 100.000 | 700.000 | 7 |
| | | 30.000 | | | |

To the water is added the ammonia (46 g) at room temperature. To the mixture is added the resin, followed by the zinc oxide. At 75 C., the TOFA and NDA is added. Once the mixture turns a dark, translucent solution, the pH is 8.27. More ammonia (4 g; 50 g total) is added. The mixture is adjusted to 30% NV by adding DI water (34.44 g).

EXAMPLE 2
30% NV Resin Cut

| Ingredients | Wt % | NV | NV % | Gms | |
|---|---|---|---|---|---|
| DI Water | 57.920 | | | 579.200 | |
| Water left out | 5.000 | | | 50.000 | |
| 28% Ammonia | 7.080 | | | 70.800 | |
| Rosin Resin #2 | 25.012 | 25.012 | 83.372 | 250.116 | pH = 8.35 |
| Tall Oil Fatty Acid | 1.843 | 1.843 | 6.144 | 18.432 | |
| (TOFA) | | | | | |
| Neodecanoic Acid | 2.927 | 2.927 | 9.757 | 29.271 | |
| NDA | | | | | |
| KP-140 | 0.000 | 0.000 | 0.000 | 0.000 | |
| Zinc Oxide | 0.218 | 0.218 | 0.727 | 2.181 | |
| Total | 100.000 | 30.000 | 100.000 | 1000.000 | 10 |
| | | 30.000 | | | |

To the water is added the ammonia (65 g) at room temperature. To the mixture is added the resin, followed by the zinc oxide. At 75 C., the TOFA and NDA is added. Once the mixture turns a dark, translucent solution, the mixture is cooled. More ammonia (5 g; 70 g total) is added. The mixture is adjusted to 30% NV by adding DI water (50.8 g).

EXAMPLE 3
30% NV Resin Cut

| Ingredients | Wt % | NV | NV % | Gms | |
|---|---|---|---|---|---|
| DI Water | 57.920 | | | 579.200 | |
| Water left out | 5.000 | | | 50.000 | |
| 28% Ammonia | 7.080 | | | 70.800 | |
| Rosin Resin #3 | 25.012 | 25.012 | 83.372 | 250.116 | pH = 8.72 |
| Tall Oil Fatty Acid | 1.843 | 1.843 | 6.144 | 18.432 | |
| (TOFA) | | | | | |
| Neodecanoic Acid | 2.927 | 2.927 | 9.757 | 29.271 | |
| NDA | | | | | |
| KP-140 | 0.000 | 0.000 | 0.000 | 0.000 | |
| Zinc Oxide | 0.218 | 0.218 | 0.727 | 2.181 | |
| Total | 100.000 | 30.000 | 100.000 | 1000.000 | 10 |
| | | 30.000 | | | |

To the water is added the ammonia at room temperature. To the mixture is added the resin, followed by the zinc oxide. At 75 C., the TOFA and NDA is added. Once the mixture turns a dark, translucent solution, the pH is 7.96. More ammonia (3.7 g; 74.5 g total) is added. The mixture is adjusted to 30% NV by adding DI water (46.3 g).

EXAMPLE 4
30% NV Resin Cut

| Ingredients | Wt % | NV | NV % | Gms | |
|---|---|---|---|---|---|
| DI Water | 57.920 | | | 405.440 | |
| Water left out | 5.000 | | | 35.000 | |
| 28% Ammonia | 7.080 | | | 49.560 | |
| Rosin Resin #4 | 25.012 | 25.012 | 83.372 | 175.081 | pH = 8.53 |
| Tall Oil Fatty Acid | 1.843 | 1.843 | 6.144 | 12.902 | |
| (TOFA) | | | | | |
| Neodecanoic Acid | 2.927 | 2.927 | 9.757 | 20.490 | |
| NDA | | | | | |
| KP-140 | 0.000 | 0.000 | 0.000 | 0.000 | |
| Zinc Oxide | 0.218 | 0.218 | 0.727 | 1.527 | |
| Total | 100.000 | 30.000 | 100.000 | 700.000 | 7 |
| | | 30.000 | | | |

To the water is added the ammonia at room temperature. To the mixture is added the resin, followed by the zinc oxide. At 75 C., the TOFA and NDA is added. Once the mixture turns a dark, translucent solution, the mixture is cooled. More ammonia (3.0 g; 52.56 g total) is added. The mixture is adjusted to 30% NV by adding DI water (32 g).

While each of the foregoing examples illustrate a separate composition of the present invention formed as a resin cut, other embodiments of the compositions are contemplated as being within the scope of this application. More specifically, the resin composition can be cut to have a NV % between 10% and 45% of the entire composition. The solution is then diluted with additional solvent and buffered to form a resin cut with the desired nonvolatile or solids level for a specific film application. The weak acids used in forming the initial resin cut solution, in addition to neutralizing the ammonia or ammonia derivatives, can assist in solubilizing the resin present, if the resin is a low molecular weight resin, to further increase the solids content of the resin cut. Also, the resin cut formed using the composition of the present invention can include the zinc oxide in amounts from 0% to 0.5% of the total resin cut composition to achieve the desired level of film durability and self-sensitivity. Further, in order to increase the solids level for the cut composition and reduce its viscosity, another plasticizer, such as tributoxyethyl phosphate, can be added to the resin cut at any time during the formation of the resin cut.

### INDUSTRIAL APPLICABILITY

The ammonia-solubilized aqueous all-resin polishing compositions of this invention can be prepared by known procedures. They are employed as protective polish coatings and can be deposited on various substrates such as wood, metal, plastic and the like using standard techniques. The coating compositions are particularly useful as floor polish compositions. They include a blended plasticizing agent which give it improved properties such as reduced ammonia-like odor and a reduced pH to improve ease of handling and use of the compositions.

Other variations and modifications of this invention will be obvious to those skilled in this art. This invention is not to be limited except as set forth in the following claims.

We hereby claim:

1. In an aqueous thermoplastic coating composition comprising water, at least one alkali-soluble polymeric film forming agent and a plasticizing agent, the improvement wherein at least a portion of the plasticizing agent is formed from a weak carboxylic acid.

2. The composition of claim 1 wherein the weak carboxylic acid is selected from the group consisting of aromatic carboxylic acids, unsaturated carboxylic acids, water-soluble carboxylic acids, water-insoluble carboxylic acids, and at least one tertiary alkyl monocarboxylic acid containing an average of from about 6 to about 30 carbon atoms per molecule, at least one unsaturated primary carboxylic acid containing an average of from about 6 to about 30 carbon atoms per molecule, and combinations thereof.

3. The composition of claim 2 wherein the tertiary alkyl monocarboxylic acid is one having the formula RR′R″CCOOH wherein each R, R′ and R″ group is an alkyl group containing at least one carbon atom and the average total number of carbon atoms in each R, R′ and R″ group is the range of from 4 to about 30.

4. The composition of claim 2 wherein the plasticizer is from 0.1% to 25% by weight of total nonvolatile solids content of the composition and the tertiary alkyl monocarboxylic acid is from 20% to 60% of the total plasticizer present.

5. The composition of claim 2 wherein the tertiary alkyl monocarboxylic acid is neodecanoic acid.

6. The composition of claim 5 wherein the neodecanoic acid is present in a ratio of about 50 parts to about 50 parts of a remaining portion of the plasticizing agent.

7. The composition of claim 2 wherein the unsaturated primary carboxylic acid is one having a formula RC═CR₁COOH wherein the R and R₁ groups are alkyl groups containing at least one carbon atom and the average total number of carbon atoms in the R and R₁ groups is in the range of from 4 to about 30.

8. The composition of claim 2 wherein the plasticizer is from 0.1% to 25% by weight of the total nonvolatile solid content of the composition and the unsaturated primary carboxylic acid is from 20% to 40% of the total plasticizer present.

9. The composition of claim 2 wherein the unsaturated primary carboxylic acid is oleic acid.

10. The composition of claim 9 wherein the oleic acid is present in a ratio of about 32 parts to about 68 parts of a remaining portion of the plasticizing agent.

11. The composition of claim 1 further comprising a polyvalent metal crosslinking agent selected from the group consisting of zinc ammonium carbonate, zirconium ammonium carbonate, and other zinc, cadmium, copper and nickel ammonium carbonate, ammonium formate or ammonium acetate complexes as well as titanate complexes.

12. The composition of claim 2 wherein the portion of the plasticizing agent is a mixture of the tertiary monocarboxylic acid and the unsaturated primary carboxylic acid.

13. The composition of claim 12 wherein the remainder of the plasticizing agent is a tributoxyethyl phosphate.

14. The composition of claim 1 wherein the alkali-soluble polymeric film forming agent is an acrylic polymer.

15. The composition of claim 1 further comprising an alkaline material used to neutralize and solubilize the at least one alkali-soluble film forming agent.

16. The composition of claim 15 wherein the alkaline material is selected from the group consisting of ammonia, primary amines, secondary amines and tertiary amines.

17. The composition of claim 16 wherein the alkaline material is selected from the group consisting of ammonium hydroxide, monoethanolamine, dimethylethanol amine, triethanol amine, and borax.

18. The composition of claim 1 wherein the at least one alkali-soluble film forming agent comprises rosin resin, acrylic polymers, styrene/acrylic polymers, polyester polymers, polyurethane polymers, polyether polymers, polyaldehyde polymers, polycarbonates, or polyamides.

19. The composition of claim 1, wherein the total nonvolatile solids percent of the composition is between 10% by weight and 45% by weight of the composition.

20. The composition of claim 19, wherein the total nonvolatile solids percent of the composition is between 20% by weight and 35% by weight of the composition.

21. The position of claim 1, wherein the weak acid is a multifunctional acid selected from the group consisting of citric acid and combinations thereof.

22. A method of improving the physical properties of an aqueous thermoplastic coating composition, comprising water, at least one alkali-soluble polymeric film forming agent comprising acrylic polymers, styrene/acrylic polymers, polyester polymers, polyurethane polymers, polyether polymers, polyaldehyde polymers, polycarbonates, or polyamides, a polyvalent metal crosslinking agent, and a plasticizing agent, wherein the improvement comprises replacing at least a portion of the plasticizing agent with a weak carboxylic acid selected from the group consisting of aromatic carboxylic acids, unsaturated carboxylic acids, water-soluble carboxylic acids, water-insoluble carboxylic acids, and combinations thereof.

23. The method of claim 22 wherein the weak carboxylic acid is selected from the group consisting of a tertiary one alkyl monocarboxylic acid, an unsaturated primary carboxylic acid, each acid containing an average of from about 6 to about 30 carbon atoms per molecule, and combinations thereof.

24. The method of claim 23 wherein the tertiary alkyl monocarboxylic acid is one having the formula RR′R″CCOOH wherein each R, R′ and R″ group is an alkyl group containing at least one carbon atom and the average total number of carbon atoms in each R, R′ and R″ group is the range of from 4 to about 30.

25. The method of claim 23 wherein the plasticizer is from 0.1% to 25% by weight of total nonvolatile solids content of the composition and the tertiary alkyl monocarboxylic acid is from 20% to 60% of the total plasticizer present.

26. The method of claim 23 wherein the unsaturated primary carboxylic acid is one having a formula RC═CR₁COOH wherein the R and R₁ groups are alkyl groups containing at least one carbon atom and the average total number of carbon atoms in the R and R₁ groups is in the range of from 4 to about 30.

27. The method of claim 23 wherein the plasticizer is from 0.1% to 25% by weight of the total nonvolatile solid content of the composition and the unsaturated primary carboxylic acid is from 20% to 40% of the total plasticizer present.

28. A method for forming a film forming composition comprising the steps of:
a) adding an amount of an alkaline compound to an amount of water to form a solution;
b) adding an amount of at least one alkali-soluble polymeric film forming agent to the solution;
c) adding an amount of at least one weak carboxylic acid to the solution; and
d) adjusting the nonvolatile weight percent of the solution.

29. The method of claim 28 wherein the at least one weak carboxylic acid is selected from the group consisting of aromatic carboxylic acids, unsaturated carboxylic acids, water-soluble carboxylic acids, water-insoluble carboxylic acids, and combinations thereof.

30. The method of claim 29 wherein the at least one weak carboxylic acid is selected from the group consisting of acetic acid, benzoic acid, citric acid, a tertiary one alkyl monocarboxylic acid, an unsaturated primary carboxylic acid, each acid containing an average of from about 6 to about 30 carbon atoms per molecule, and combinations thereof.

31. The method of claim 28 wherein the step of adjusting the nonvolatile weight percent of the solution comprises adding addition water to the solution.

32. The method of claim 28 further comprising the step of adding a buffering agent to the solution after adding the amount of the at least one weak carboxylic acid to the solution.

33. The method of claim 28 further comprising the step of adding a metal complexing agent to the solution after adding the amount of the at least one alkali-soluble polymeric film forming agent to the solution.

34. The method of claim 28 further comprising the step of adding at least one plasticizing agent to the solution after adding the alkaline compound to the water to form the solution.
